(19) United States
(12) Patent Application Publication
(10) Pub. No.: US 2008/0183650 A1
(43) Pub. Date: Jul. 31, 2008

(54) DOCUMENT MANAGEMENT APPARATUS AND DOCUMENT MANAGEMENT METHOD

(75) Inventor: Noriyuki Komamura, Shizuoka-ken (JP)

Correspondence Address: AMIN, TUROCY & CALVIN, LLP, 1900 EAST 9TH STREET, NATIONAL CITY CENTER, 24TH FLOOR,, CLEVELAND, OH, 44114, US

(73) Assignees: KABUSHIKI KAISHA TOSHIBA, Tokyo (JP); TOSHIBA TEC KABUSHIKI KAISHA, Tokyo (JP)

(21) Appl. No.: 11/668,177

(22) Filed: Jan. 29, 2007

(51) Int. Cl. G06G 7/00; G06E 3/00

(52) U.S. Cl. 706/21; 715/805

(57) ABSTRACT

It is an object to manage a document including deadline information and to notify the deadline information to a user before a deadline date, and there are included a deadline metadata acquisition unit to acquire metadata relating to a deadline from an electronic document created by electronic data, a deadline estimation unit to estimate a deadline determined for the electronic document from the acquired metadata, and a deadline notification control unit to manage the estimated deadline and to notify a user of the deadline.

### BACKGROUND OF THE INVENTION

1. Field of the Related Art

The present invention relates to a document management apparatus and a document management method for managing a document including deadline information.

2. Description of the Related Art

Hitherto, there is known a technique in which deadline information is used to manage a document in order to prevent the deadline for submission or the deadline for use from expiring fruitlessly. For example, there is known one in which relevance among metadata is used to retrieve information relevant to digital content indicated by the metadata or commodities (see, for example, JP-A-2005-196540).

Besides, there is also known a technique having an object of providing a retrieval engine in which delicate metadata representing raw data of various forms can be registered, so that an answer closer to information required by a user can be given (see, for example, JP-A-2001-147941).

However, these techniques of the related art are utilized in a use in which the deadline information associated with the document is made impossible to be used when the deadline expires, and in a use in which the deadline information is deleted when the deadline expires, and the techniques are not such that the deadline information is notified in order to urge the user to take an action before the deadline expires.

### SUMMARY OF THE INVENTION

The invention has been made in view of the foregoing problem, and has an object to provide a document management apparatus and a document management method in which when a deadline approaches, deadline information is notified to the user, so that the use of a document is positively urged, documents, the worth of which might be heretofore lost by unintentional forgetfulness, are reduced, and the realization of effective use of created documents is enabled.

In order to solve the problem, a document management apparatus of the invention includes a deadline metadata acquisition unit configured to acquire metadata relating to a deadline from an electronic document created by electronic data, a deadline estimation unit configured to estimate a deadline determined for the electronic document from the metadata acquired by the deadline metadata acquisition unit, and a deadline notification control unit configured to manage the deadline estimated by the deadline estimation unit and to notify a user of the deadline.

Besides, a document management apparatus of the invention includes deadline metadata acquisition means for acquiring metadata relating to a deadline from an electronic document created by electronic data, deadline estimation means for estimating a deadline determined for the electronic document from the metadata acquired by the deadline metadata acquisition means, and deadline notification control means for managing the deadline estimated by the deadline estimation means and for notifying a user of the deadline.

Further, a document management method of the invention includes acquiring metadata relating to a deadline from an electronic document created by electronic data, estimating a deadline determined for the electronic document from the acquired metadata, managing the estimated deadline and notifying a user of the deadline.

### DESCRIPTION OF THE DRAWINGS

FIG. 1 is a block diagram showing a structure of a document management system of an embodiment of the invention.

FIG. 2 is a block diagram showing a structure of a document management apparatus of the embodiment of the invention.

FIG. 3 is a flowchart showing a processing operation of deadline information extraction in the document management apparatus of the embodiment of the invention.

FIG. 4 is a view showing an example of a document including deadline information.

FIG. 5 is a view showing an example of a document including deadline information.

FIG. 6 is a view showing an example of a document including deadline information.

FIG. 7 is a view showing an example of data in a deadline information storage unit.

FIG. 8 is a flowchart showing a processing operation of deadline information notification in the document management apparatus.

FIG. 9 is a view showing an example of a deadline notification display to a user.

FIG. 10 is a view showing an example of a deadline notification method setting screen to a user.

FIG. 11 is a view showing an example in which deadline information is overlaid and displayed.

### DESCRIPTION OF THE EMBODIMENT

Hereinafter, embodiments of the invention will be described with reference to the drawings.

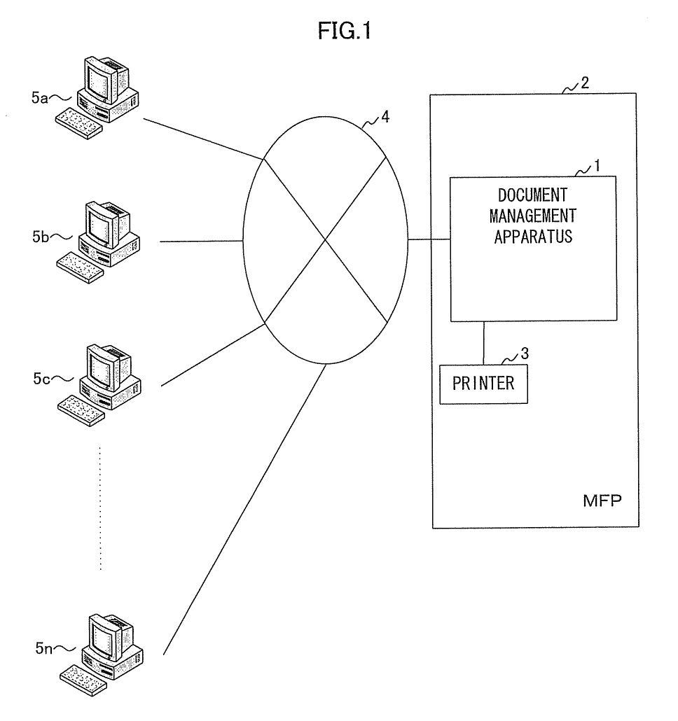

FIG. 1 is a block diagram showing a structure of a document management system of an embodiment of the invention.

A document management apparatus 1 is one of components of an MFP2, and is connected to clients 5a, 5b, 5c, . . . , 5n through a network 4.

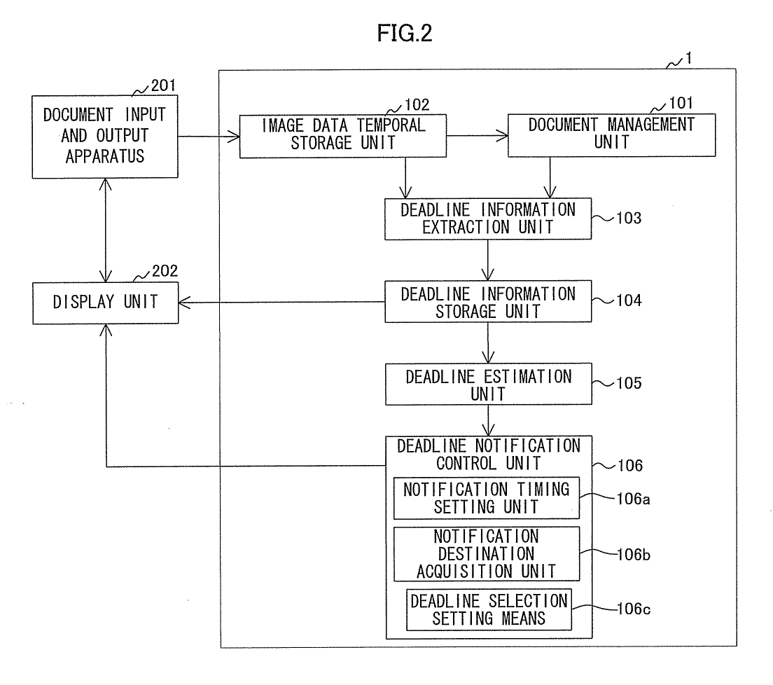

FIG. 2 is a block diagram showing a structure of the document management apparatus 1. The document management apparatus 1 includes a document management unit 101, an image data temporal storage unit 102, a deadline information extraction unit (deadline metadata acquisition unit, deadline metadata acquisition means) 103, a deadline information storage unit 104, a deadline estimation unit (deadline estimation means) 105, and a deadline notification control unit (deadline notification control means) 106.

Further, the document management apparatus 1 is connected to a document input and output apparatus 201 and a display unit 202 in the clients 5a to 5n through the network 4.

The document input and output apparatus 201 is an apparatus which has functions of print, scan, FAX, copy and the like and in which a paper document and an electronic document are treated.

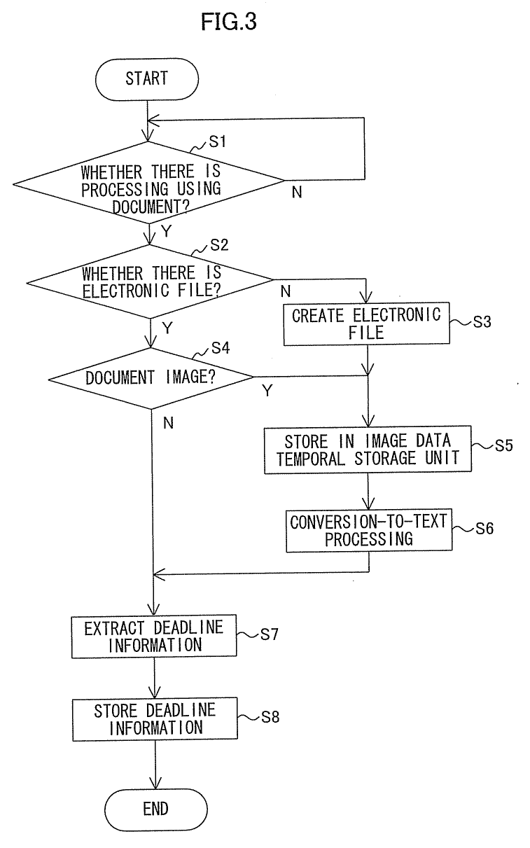

A processing operation of deadline information extraction in the document management apparatus 1 of the structure as stated above will be described by use of a flowchart of FIG. 3.

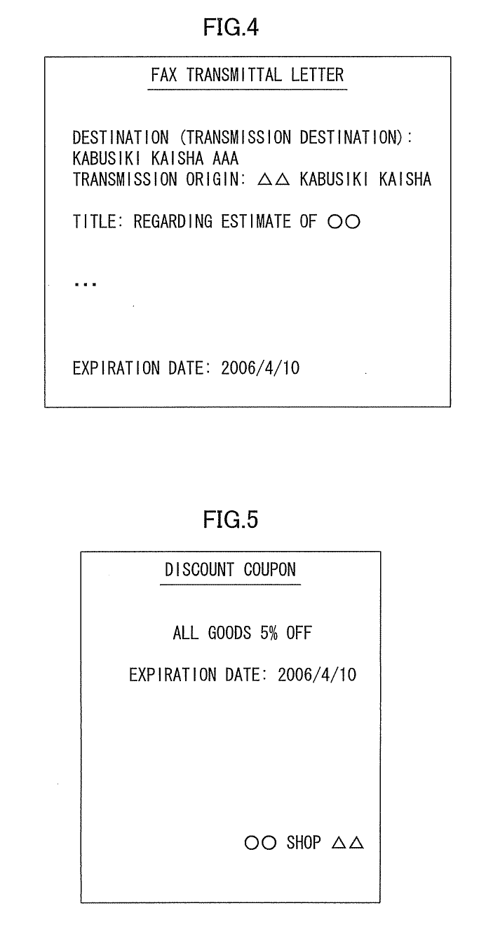

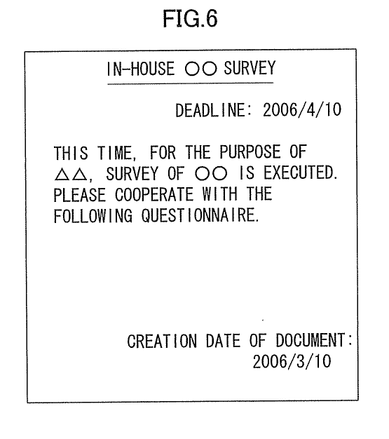

In this operation, when a document (an example is shown in FIGS. 4, 5 and 6) including deadline information is used in the document input and output apparatus 201, the processing is started. When the processing using the document occurs (step S1, Y), it is determined whether or not a form of an electronic file is used for that (step S2), and in the case where the form of the electronic file is not used, for example, in the case where by the use of the function of FAX, copy or the like, the document is not treated as an electronic file in a normal processing and accordingly, the electronic file does not normally remain in the apparatus (memory) (step S2, N), an electronic file is created (step S3), and is temporarily stored in the image data temporal storage unit 102 (step S5).

On the other hand, at the processing of step S1, in the case where the form of the electronic file is used, for example, in the case where by the use of the function of print, scan or the like, the document remains, in the normal processing, as the electronic file in the apparatus (memory) (step S2, Y), it is determined whether or not the electronic file is a document image (step S4).

At the processing of step S4, in the case where it is determined that the electronic file is not the document image, that is, in the case where the electronic file to be treated includes character information, not the document image (step S4, N), when deadline meta-information is previously associated, as property information or metadata, with the document, the deadline information extraction unit 103 directly extracts it. On the other hand, in the case where the deadline meta-information is not associated, as property information or metadata, with the document, the deadline information extraction unit 103 uses a semantic class analysis technique or the like on the document, and extracts deadline information and deadline metadata (step S7). The extracted deadline information is stored in the deadline information storage unit 104 (step S8).

On the other hand, at the processing of step S4, in the case where it is determined that the electronic file is the document image (step S4, Y), advance is made to step S5, and it is temporarily stored in the image data temporal storage unit 102.

The document image stored in the image data temporal storage unit 102 is next subjected to the conversion-to-text processing (step S6), and advance is made to step S7.

In the conversion-to-text processing at step S6, first, the analysis of the document image is performed. Here, the area type in the document image is analyzed by an area separation technique, and a separation is made into a character area and an image area. Next, by the layout analysis technique, from the position information of the area determined to be the character area, it is determined the area is of what kind. Further, by the semantic class analysis technique, it is determined that the information of the character area has what meaning and the extraction is performed.

Incidentally, in the extraction processing of the deadline information at step S7, among character areas determined to have “date”, as a standard based on which it is determined to be “deadline” information, there is used such a condition that a character string which can be determined to be the deadline information, such as “until” or “punctual”, is arranged in the area or before or after that.

Besides, when the deadline information is extracted, in the case where date information newer than the present date information is not contained in the document, it is determined that there is no deadline information to be notified, and storage into the deadline information storage unit 104 is not performed.

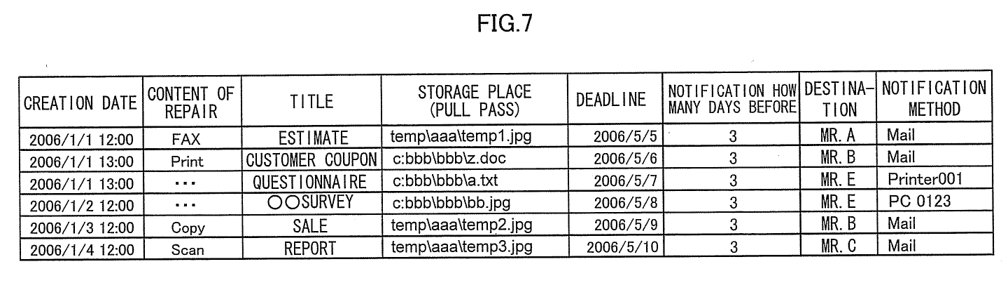

“Information relevant to deadline information” is information (file name, file path information) to specify the document and attribute information (metadata), which indicates that for example, when the deadline of the document has approached, it is notified to whom (address), and what deadline of what document has approached (title). An example of the data in the deadline information storage unit is shown in FIG. 7.

In the above operation, the step S7 constitutes document specifying information acquisition unit and document specifying information acquisition means in this embodiment of the invention.

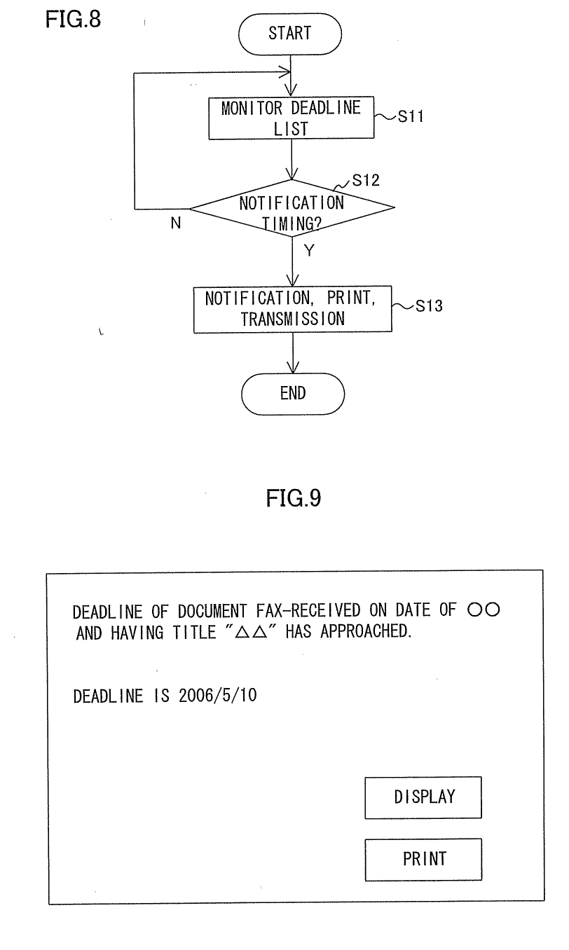

Next, the processing operation of deadline information notification in the document management apparatus 1 will be described by use of a flowchart of FIG. 8.

The deadline estimation unit 105 monitors a deadline information list stored in the deadline information storage unit 104 (step S11), and calculates a date of notification from the value of “deadline information” and the value of “notification timing” in the deadline information storage unit 104. When the date of notification has come (step S12, Y), the deadline notification control unit 106 notifies the user through the display unit 202 on the client side (step S13). An example of notification display to the user is shown in FIG. 9.

With respect to the notification timing to the user, the deadline notification control unit 106 includes a notification timing setting unit (notification timing setting means) 106a, and as desired, the user himself or herself can set that the notification is performed how many days before the deadline. The data of the deadline information storage unit 104 can be displayed to the user by the display unit 202 or the like, and the user can directly edit that. For example, when there is an error in reading the deadline information, it is corrected, or the once set notification timing is changed, or the setting can also be made so that the notification is repeatedly performed until the deadline.

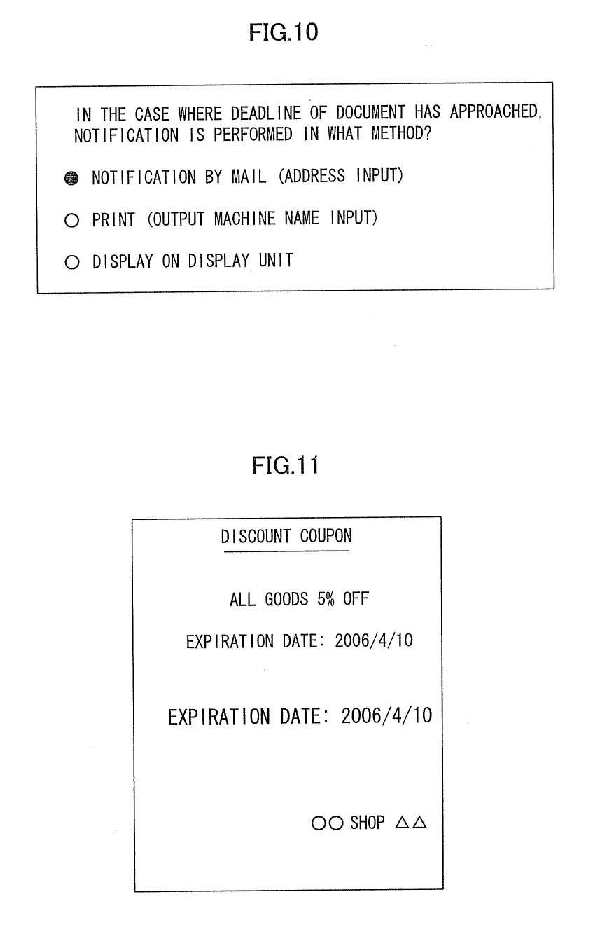

Also with respect to the notification method, it can be previously registered on a notification method setting screen of the display unit 202 as shown in FIG. 10.

In the case where mail notification is desired, although the mail address of a notification destination can be directly inputted by the user on the notification method setting screen of FIG. 10, the deadline notification control unit 106 includes a notification destination acquisition unit (notification destination acquisition means) 106b, and the notification destination address can also be known by cooperation of the “destination” information extracted by the semantic class analysis in the deadline information extraction unit 103 and an apparatus in which external user information, such as MFP use information, is managed. For example, in the case where the destination is “name”, the mail address corresponding to the “name” character information is acquired from the external user information DB in which the user information is stored, and the mail address can be notified.

Besides, in the case where notification by printing is desired, when a printer close to the user is registered in the user information DB, the deadline notification control unit 106 can also automatically make an output as paper document by that.

Besides, in the case where display is performed on the display unit, the deadline notification control unit 106 can display a screen in which the deadline information and the document are combined, can perform the display while a feature is attached, for example, a color is attached to a deadline information area, or can perform the display while a metadata portion relevant to the deadline of the document is made noticeable. Further, the deadline notification control unit 106 can also display the document image combined with the deadline information by watermark, overlay or the like. One example is shown in FIG. 11. Incidentally, what is displayed on the display unit can also be printed on a paper document.

Besides, the information of the document can also be registered on the relevant deadline date of a scheduler of the user.

Besides, in the case where metadata relating to plural deadlines is acquired in the deadline information extraction unit 103, the deadline estimation unit 105 estimates the earliest deadline as the deadline of the document. The deadline notification control unit 106 can notify the earliest deadline, and can also notify the deadline estimated from the metadata relating to the plural deadlines.

Besides, the deadline notification control unit 106 includes a deadline selection setting unit (deadline selection setting means) 106c, and can cause the user to select one deadline from plural deadlines, and can manage it as the deadline of the document.

The deadline metadata acquisition means, the deadline estimation means, the deadline notification control means, the notification timing setting means, the notification destination acquisition means, and the deadline selection setting means described in this embodiment can be applied also to a program of causing a computer to execute the document management method described by the flowchart shown in the embodiment. This program is recorded on a computer readable recording medium, is read by the computer, and has a function to cause the computer to execute the document management method of the invention. With respect to the function as stated above, in the embodiment, although the description has been made on the case where the function to carry out the invention is previously recorded in the inside of the apparatus, no limitation is made to this, and a similar function may be downloaded from a network to the apparatus, or a similar function recorded on a recording medium may be installed in the apparatus. As the recording medium, any form may be adopted as long as the recording medium, such as a CD-ROM, can store the program and can be read by the apparatus. Besides, the function obtained by the previous installation or download may realize the function in cooperation with an OS (Operating System) of the inside of the apparatus.

What is claimed is:

1. A document management apparatus comprising:
a deadline metadata acquisition unit configured to acquire metadata relating to a deadline from an electronic document created by electronic data;
a deadline estimation unit configured to estimate a deadline determined for the electronic document from the metadata acquired by the deadline metadata acquisition unit;
a deadline notification control unit configured to manage the deadline estimated by the deadline estimation unit and to notify a user of the deadline.

2. The document management apparatus according to claim 1, wherein the deadline metadata acquisition unit acquires, on condition that one of a print function, a scan function and a FAX function is executed, the deadline metadata from the electronic document relating to the function execution.

3. The document management apparatus according to claim 1, further comprising a document specifying information acquisition unit configured to acquire information to specify the electronic document from the electronic document, wherein
the deadline notification control unit manages, together with the deadline information, the specifying information of the electronic document acquired by the document specifying information acquisition unit.

4. The document management apparatus according to claim 3, wherein the specifying information includes one of a file name, file path information, and metadata other than the deadline, or a combination of these.

5. The document management apparatus according to claim 1, wherein the deadline notification control unit includes a notification destination acquisition unit configured to acquire, based on information relating to content of the document or use information of the apparatus, a notification destination of the user to whom the deadline is notified, and notifies the deadline to the user of the notification destination.

6. The document management apparatus according to claim 1, wherein the deadline notification control unit causes the deadline to be registered in a scheduler of a terminal apparatus of the user.

7. The document management apparatus according to claim 1, wherein the deadline notification control unit includes a notification timing setting unit capable of setting a timing when the notification is performed with respect to the deadline, and notifies the deadline to user at the timing set by the notification timing setting unit.

8. The document management apparatus according to claim 1, wherein at the notification of the deadline, the deadline notification control unit outputs and displays the electronic document combined with information of the deadline when the notification is performed.

9. The document management apparatus according to claim 8, wherein the deadline notification control unit emphasizes a metadata portion relating to the deadline of the electronic document acquired by the deadline metadata acquisition unit and performs an output display.

10. The document management apparatus according to claim 8, wherein the deadline notification control unit outputs and displays an image in which the information of the deadline is combined by one of watermark and overlay when the notification is performed.

11. The document management apparatus according to claim 8, wherein the deadline notification control unit print-outputs the image.

12. The document management apparatus according to claim 1, wherein in a case where metadata relating to plural deadlines is acquired by the deadline metadata acquisition unit, the deadline estimation unit estimates the earliest deadline among the plural deadlines as the deadline of the electronic document, and the deadline notification control unit notifies the earliest deadline as the deadline of the electronic document.

13. The document management apparatus according to claim 12, wherein when the deadline is notified, the deadline notification control unit notifies also the deadline estimated from the metadata relating to the plural deadlines.

14. The document management apparatus according to claim 13, wherein the deadline notification control unit includes a deadline selection setting unit configured to urge the user to select and set one deadline from the plural deadlines when the deadline is notified, and manages the deadline selected and set by the deadline selection setting unit as the deadline of the document.

15. A document management apparatus comprising:
deadline metadata acquisition means for acquiring metadata relating to a deadline from an electronic document created by electronic data;
deadline estimation means for estimating a deadline determined for the electronic document from the metadata acquired by the deadline metadata acquisition means; and
deadline notification control means for managing the deadline estimated by the deadline estimation means and for notifying a user of the deadline.

16. The document management apparatus according to claim 15, wherein the deadline metadata acquisition means acquires, on condition that one of a print function, a scan function and a FAX function is executed, the deadline metadata from the electronic document relating to the function execution.

17. The document management apparatus according to claim 15, further comprising document specifying information acquisition means for acquiring information to specify the electronic document from the electronic document, wherein
the deadline notification control means manages, together with the deadline information, the specifying information of the electronic document acquired by the document specifying information acquisition means.

18. The document management apparatus according to claim 17, wherein the specifying information includes one of a file name, file path information, and metadata other than the deadline, or a combination of these.

19. The document management apparatus according to claim 15, wherein the deadline notification control means includes notification destination acquisition means for acquiring, based on information relating to content of the document or use information of the apparatus, a notification destination of the user to whom the deadline is notified, and notifies the deadline to the user of the notification destination.

20. A document management method comprising:
acquiring metadata relating to a deadline from an electronic document created by electronic data;
estimating a deadline determined for the electronic document from the acquired metadata; and
managing the estimated deadline and notifying a user of the deadline.
